(19) United States
(12) Patent Application Publication
(10) Pub. No.: US 2022/0204752 A1
(43) Pub. Date: Jun. 30, 2022

(54) BIODEGRADABLE POLYESTER AND METHOD FOR PREPARING THE SAME

(71) Applicant: INDUSTRIAL TECHNOLOGY RESEARCH INSTITUTE, Hsinchu (TW)

(72) Inventors: Jin-An WU, Huwei Township (TW); Jen-Chun CHIU, Zhubei City (TW); Sheng-Lung CHANG, Taoyuan City (TW); Fan-Jie LIN, New Taipei City (TW); Yun-Chen CHANG, Taichung City (TW)

(73) Assignee: INDUSTRIAL TECHNOLOGY RESEARCH INSTITUTE, Hsinchu (TW)

(21) Appl. No.: 17/139,107

(22) Filed: Dec. 31, 2020

(51) Int. Cl. C08L 67/02; C08L 63/04; C08G 59/24; C08G 59/30

(52) U.S. Cl. CPC C08L 67/02; C08L 63/04; C08L 2201/06; C08G 59/302; C08G 59/245

(57) ABSTRACT

A biodegradable polyester and a method for preparing a biodegradable polyester are provided. The biodegradable polyester is a product of a reactant (A) and a reactant (B) via polycondensation. The reactant (A) is a product of a reactant (C) and a reactant (D) via an esterification reaction. The reactant (B) is at least one epoxy resin with a secondary hydroxyl functional group. The reactant (C) is at least one diol, and the reactant (D) is at least one dicarboxylic acid, at least one acid anhydride, or a combination thereof.

### TECHNICAL FIELD

The disclosure relates to a biodegradable polyester and method for preparing the same.

### BACKGROUND

The rise of plastic packaging material is closely related to a general change of lifestyle. The use of light, convenient packaging for food storage and transportation, as well as increasing the shelf life of food, has become very important due to pressure from high population growth rates and food shortages. Although plastic packaging at present can satisfy demand, the consumption of plastic has exceeded 160 million tons annually, of which 35% is used as packaging material. The treatment of waste from packaging material has a huge impact on the environment, so recycling plastic and studying degradable plastic have become more and more important.

Biodegradable material is a new type of polymer, which is characterized by the self-decomposition when its function completes. The bonding between these polymers decomposes into environmentally friendly compositions through biological processes. Biodegradable materials exhibit better environmental compatibility than conventional materials. Currently, mainstream common biodegradable materials include polylactic acid (PLA), poly(butyleneadipate-co-terephthalate) (PBAT), or PLA-starch-blending (or PBAT-starch-blending) materials. The conventional biodegradable materials, however, would be completely decomposed under industrial composting conditions, and exhibit poor mechanical properties in comparison with common packaging materials (such as polyethylene (PE) or polypropylene (PP)), thereby limiting the application thereof. Polybutylene succinate (Polybutylene succinate, PBS) exhibits better biodegradability, great heat resistance and mechanical strength, thereby meeting the requirements of environmental protection (the raw material is a biomass source). Conventional polybutylene succinate, however, exhibits poor processability and has narrow application range due to its insufficient viscosity and melt strength resulting from the structure thereof.

### SUMMARY

The disclosure provides a biodegradable polyester. According to embodiments of the disclosure, the biodegradable polyester can be a product of a reactant (A) and a reactant (B) via polycondensation, wherein the reactant (A) can be a reaction product of a reactant (C) and a reactant (D) via an esterification, wherein the reactant (B) can be at least one epoxy resin with a secondary hydroxyl functional group, the reactant (C) can be at least one diol, and the reactant (D) can be a at least one dicarboxylic acid, at least one acid anhydride, or a combination thereof.

According to embodiments of the disclosure, the disclosure also 2 0 provides a method for preparing a biodegradable polyester of the disclosure.

According to embodiments of the disclosure, the method includes subjecting a first composition to an esterification to obtain an oligomer, wherein the first composition includes a first reactant and a second reactant, and wherein the first reactant is at least one diol, and the second reactant is at least one dicarboxylic acid, at least one acid anhydride, or a combination thereof, and subjecting a second composition to polycondensation, wherein the second composition includes at least one the oligomer and at least one epoxy resin with a secondary hydroxyl functional group.

A detailed description is given in the following embodiments.

### DETAILED DESCRIPTION

The biodegradable polyester and method for preparing the same of the disclosure are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. As used herein, the term “about” in quantitative terms refers to plus or minus an amount that is general and reasonable to persons skilled in the art.

As used herein, the term “about” in quantitative terms refers to plus or minus an amount that is general and reasonable to persons skilled in the art.

Moreover, the use of ordinal terms such as “first”, “second”, “third”, etc., in the disclosure to modify an element does not by itself connote any priority, precedence, or order of one claim element over another or the temporal order in which it is formed, but are used merely as labels to distinguish one claim element having a certain name from another element having the same name (but for use of the ordinal term) to distinguish the claim elements.

The disclosure provides a biodegradable polyester and a method for preparing a biodegradable polyester. In the method for preparing a biodegradable polyester of the disclosure, a diglycidyl ether-based epoxy resin having a secondary hydroxyl functional group with a molecular weight greater than 300 (g/mol) is introduced to react with a polyester oligomer. The secondary hydroxyl functional group of the segment, which is derived from the diglycidyl ether-based epoxy resin, of the obtained biodegradable polyester can form a relative strong intramolecular hydrogen bond (in comparison with a primary hydroxyl functional group) with the oxygen atom of the segment, which is derived from the polyester oligomer. As a result, the obtained biodegradable polyester can exhibit suitable melt strength and melt flow index (for example the biodegradable polyester has a melt strength of 30 mN to 100 mN and a melt flow index of 0.5 g/10 min to 10 g/10 min) on the premise that the biodegradability of the obtained biodegradable polyester is not affected. Therefore, the processability of the biodegradable polyester for subsequent process can be improved. According to embodiments of the disclosure, the biodegradable polyester of the disclosure can be applied in the production of shopping bags and functional films by film blowing processes and film extrusion processes.

According to embodiments of the disclosure, the biodegradable polyester of the disclosure can be a product of a reactant (A) and a reactant (B) via polycondensation, wherein the reactant (A) is a product of a reactant (C) and a reactant (D) via an esterification reaction. According to embodiments of the disclosure, the reactant (B) is at least one epoxy resin with a secondary hydroxyl functional group. According to embodiments of the disclosure, the reactant (C) is at least one diol, and the reactant (D) is at least one dicarboxylic acid, at least one acid anhydride, or a combination thereof.

According to embodiments of the disclosure, the epoxy resin with a secondary hydroxyl functional group of the disclosure can be a diglycidyl ether-based epoxy resin with a secondary hydroxyl functional group. According to embodiments of the disclosure, the epoxy resin with a secondary hydroxyl functional group can have a repeating unit, and the repeating unit has a secondary hydroxyl functional group. According to embodiments of the disclosure, the number average molecular weight of the epoxy resin with a secondary hydroxyl functional group can be greater than or equal to 300 (g/mol), such as greater than or equal to 500 (g/mol), greater than or equal to 800 (g/mol), greater than or equal to 1,000 (g/mol), greater than or equal to 1,200 (g/mol), greater than or equal to 1,500 (g/mol), greater than or equal to 1,800 (g/mol), greater than or equal to 2,000 (g/mol), or greater than or equal to 3,000 (g/mol). According to embodiments of the number average molecular weight of the epoxy resin with a secondary hydroxyl functional group of the disclosure can be 300 (g/mol) to 8,000 (g/mol), such as 500 (g/mol) to 8,000 (g/mol), 800 (g/mol) to 8,000 (g/mol), 1,000 (g/mol) to 8,000 (g/mol), 1,500 (g/mol) to 5,000 (g/mol), 2,000 (g/mol) to 8,000 (g/mol), or 3,000 (g/mol) to 8,000 (g/mol). When the number average molecular weight of the epoxy resin with a secondary hydroxyl functional group is too low, the biodegradable polyester of the disclosure would exhibit poor processability due to over-cross-linking degree or high OH value. When the number average molecular weight of the epoxy resin with a secondary hydroxyl functional group is too high, the biodegradable polyester of the disclosure exhibits reduced degree of polymerization, thereby deteriorating the processability and properties of material.

According to embodiments of the disclosure, the epoxy resin with a secondary hydroxyl functional group can be has a bisphenol A type diglycidyl ether epoxy resin having a secondary hydroxyl functional group, novolac diglycidyl ether epoxy resin having a secondary hydroxyl functional group, bisphenol F type diglycidyl ether epoxy resin having a secondary hydroxyl functional group, bisphenol S type diglycidyl ether epoxy resin having a secondary hydroxyl functional group, alicyclic diglycidyl ether epoxy resin having a secondary hydroxyl functional group, halogenated bisphenol A type diglycidyl ether epoxy resin having a secondary hydroxyl functional group, hydrogenation bisphenol A type diglycidyl ether epoxy resin having a secondary hydroxyl functional group, or a combination thereof.

According to embodiments of the disclosure, the epoxy resin with a secondary hydroxyl functional group can have a structure represented by Formula (I) or Formula (II):

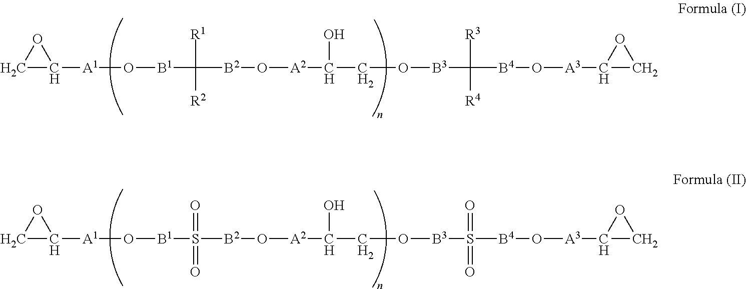

wherein R¹-R⁴ are independently hydrogen, fluorine, C₁₋₆ alkyl group, or C₁₋₆ fluoroalkyl group; A¹, A² and A³ are independently C₁₋₈ alkylene group; B¹, B², B³, and B⁴ are independently C₆₋₁₈ arylene group, C₄₋₈ cycloalkylene group, C₄₋₁₈ heteroarylene group, C₄₋₁₂ alicyclic alkylene group, or divalent C₇-C₂₅ alkylaryl group; and, n is 0, or an integer from 1-30.

According to embodiments of the disclosure, the non-substituted C₁₋₈ alkylene group can be linear or branched alkylene group. for example, C₁₋₈ alkylene group can be methylene group, ethylene group, propylene group, butylene group, pentylene group, hexylene group, heptylene group, octylene group or an isomer thereof. According to embodiments of the disclosure, C₁₋₆ alkyl group can be linear or branched alkyl group. for example, C₁₋₆ alkyl group can be methyl, ethyl, propyl, butyl, pentyl, hexyl, or an isomer thereof. According to embodiments of the disclosure, C₁₋₆ fluoroalkyl group can be an alkyl group which a part of or all hydrogen atoms bonded on the carbon atom are replaced with fluoride atoms, and C₁₋₆ fluoroalkyl group can be linear or branched fluoroalkyl group, such as fluoromethyl, fluoroethyl, fluoropropyl, group, fluorobutyl group, fluoropentyl group, fluorohexyl group, or an isomer thereof.

According to embodiments of the disclosure, the epoxy resin with a secondary hydroxyl functional group can be

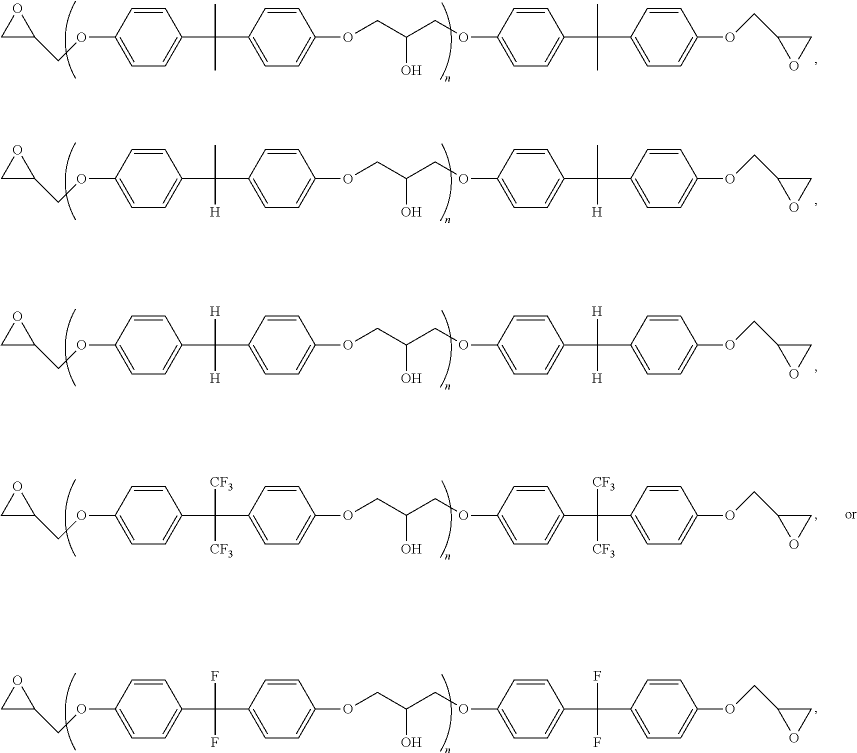

wherein n can be 0, or an integer from 1-30.

According to embodiments of the disclosure, the reactant (B) can be at least two epoxy resin with a secondary hydroxyl functional group. According to embodiments of the disclosure, the at least two epoxy resin with a secondary hydroxyl functional group can be epoxy resins with the same repeating unit but different n value. According to embodiments of the disclosure, the average value of n of the at least two epoxy resin with a secondary hydroxyl functional group can be about 0.1 to 29, such as 0.2, 0.5, 0.7, 1, 2, 3, 4, 5, 6, 7, 8, 9, 10, 11, 12, 13, 14, 15, 16, 17, 18, 19, 20, 21, 22, 23, 24, 25, 26, 27, or 28.

According to embodiments of the disclosure, the amount of reactant (A) (i.e. the esterified oligomer prepared from dicarboxylic acid and diol, the esterified oligomer prepared from acid anhydride and diol, or the esterified oligomer prepared from dicarboxylic acid, acid anhydride and diol) can be 100 parts by weight, and the amount of reactant (B) (i.e. the epoxy resin with a secondary hydroxyl functional group) can be 0.1-5 parts by weight (such as 0.2, 0.3, 0.4, 0.5, 0.8, 1, 2, 3, or 4). When the amount of epoxy resin with a secondary hydroxyl functional group is too low, the melt strength and melt flow index of the obtained biodegradable polyester cannot be enhanced to a suitable range, resulting in that the obtained biodegradable polyester exhibits poor processability. When the amount of epoxy resin with a secondary hydroxyl functional group is too high, the biodegradable polyester of the disclosure exhibits reduced degree of polymerization, thereby deteriorating the processability and properties of material.

According to embodiments of the disclosure, the biodegradable polyester of the disclosure can be a product of a composition via polycondensation. According to embodiments of the disclosure, the composition includes polyester oligomer and epoxy resin with a secondary hydroxyl functional group. According to embodiments of the disclosure, the composition consists of polyester oligomer and epoxy resin with a secondary hydroxyl functional group. According to embodiments of the disclosure, the polyester oligomer can be a product of the reactant (C) and the reactant (D) via esterification. According to embodiments of the disclosure, the reactant (C can be at least one diol, and the reactant (D) can be a at least one dicarboxylic acid, at least one acid anhydride, or a combination thereof.

According to embodiments of the disclosure, the dicarboxylic acid can be a compound having a structure represented by Formula (III):

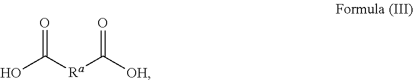

wherein R^{a} is independently C₁₋₈ alkylene group, C₆₋₁₈ arylene group, C₄₋₈ cycloalkylene group, C₄₋₁₈ heteroarylene group, C₄₋₁₂ alicyclic alkylene group, or divalent C₇-C₂₅ alkylaryl group. According to embodiments of the disclosure, the dicarboxylic acid can be malonic acid, succinic acid, glutaric acid, adipic acid, pimelic acid, suberic acid, terephthalic acid), or isophthalic acid.

According to embodiments of the disclosure, the acid anhydride can be a compound having a structure represented by Formula (IV) or Formula (V):

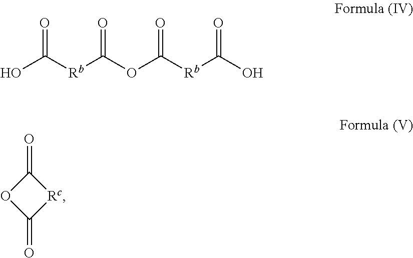

wherein R^{b} is independently C₁₋₈ alkylene group, C₆₋₁₈ arylene group, C₄-C₈ cycloalkylene group, C₄₋₁₈ heteroarylene group, C₄₋ alicyclic alkylene group, or divalent C_{7-≅}alkylaryl group; and, R^{c} is independently C₂₋₈ alkylene group, C₆₋₁₈ arylene group, C₅₋₈ cycloalkylene group, C₄₋₁₈ heteroarylene group, C₄₋₁₂ alicyclic alkylene group, or divalent C₇-C₂₅ alkylaryl group. For example, the acid anhydride can be acetic anhydride, succinic anhydride, maleic anhydride, n-dodecyl succinic anhydride, n-tetradecyl succinic anhydride, methacrylic anhydride, phthalic anhydride, or benzoic anhydride.

According to embodiments of the disclosure, the diol can be a compound having a structure represented by Formula (VI):

HO—R^{d}—OH_{Formula} (VI),

wherein R^{d} is independently C₁₋₈ alkylene group, C₆₋₁₈ arylene group, C₄₋₈ cycloalkylene group, C₄₋₁₈ heteroarylene group, C₄₋₁₂ alicyclic alkylene group, or divalent C₇-C₂₅ alkylaryl group. for example, the diol can be ethylene glycol, propylene glycol, butanediol, pentanediol, hexanediol, heptanediol, octanediol, or hydroquinone.

According to embodiments of the disclosure, the molar ratio of the reactant (C) (i.e. diol) to the reactant (D) (i.e. dicarboxylic acid, acid anhydride, or a combination thereof) can be about 1:1 to 1.5:1. When the molar ratio of the reactant (C) to the reactant (D) is greater than 1, it ensures that the obtained oligomer has a terminal hydroxyl group in order to react with the epoxy resin with a secondary hydroxyl functional group.

According to embodiments of the disclosure, the reactant (C) can be butanediol, and the reactant (D) can be succinic acid. According to embodiments of the disclosure, the reactant (C) can be butanediol, and the reactant (D) can be succinic acid and adipic acid. According to embodiments of the disclosure, the reactant (C) can be ethylene glycol, and the reactant (D) can be succinic acid.

According to embodiments of the disclosure, the reactant (C) can be butanediol, and the reactant (D) can be adipic acid and terephthalic acid. According to embodiments of the disclosure, the reactant (C) can be butanediol, and the reactant (D) can be succinic acid and terephthalic acid.

According to embodiments of the disclosure, the polyester oligomer can be polybutylene succinate (PBS) oligomer, polybutylene succinate adipate (PBSA) oligomer, polyethylene succinate (PES) oligomer, polybutylene dipate/terephthalate (PBAT) oligomer, polybutylene succinate/terephthalate (PBST) oligomer, or a combination thereof. According to embodiments of the disclosure, the number average molecular weight (Mn) of the polyester oligomer can be about 100 to 8,000, such as about 200 to 8,000, 100 to 6,000, 200 to 5,000, 300 to 5,000, or 500 to 5,000. When the molecular weight of the polyester oligomer is too high, the obtained biodegradable polyester is difficult to react with the reactant (B) to undergo polycondensation. As a result, the melt strength and melt flow index of the obtained biodegradable polyester cannot be enhanced effectively, resulting in that the obtained biodegradable polyester exhibits poor processability.

According to embodiments of the disclosure, the number average molecular weight of the biodegradable polyester of the disclosure can be about 5,000g/mol to 500,000g/mol, such as 10,000 g/mol to 500,000g/mol, 10,000g/mol to 300,000g/mol, or 20,000g/molto 100,000g/mol. The weight average molecular weight (Mw) of the oligomer, epoxy resin or biodegradable polyester of the disclosure can be determined by gel permeation chromatography (GPC) based on a polystyrene calibration curve. According to embodiments of the disclosure, when the molecular weight of the biodegradable polyester is too high or too low, the biodegradable polyester exhibits poor processability.

According to embodiments of the disclosure, the biodegradable polyester can have a melt strength of 30 mN to 100 mN, and the biodegradable polyester can have a melt flow index of 0.5 g/10 min to 10 g/10 min, in order to enhance the processability of the biodegradable polyester.

According to embodiments of the disclosure, the disclosure also provides a method for preparing a biodegradable polyester of the disclosure. According to embodiments of the disclosure, the method for preparing a biodegradable polyester includes following steps. A first composition is subjected to an esterification, obtaining an oligomer, wherein the first composition includes first reactant and the second reactant, wherein the first reactant is at least one diol, and the second reactant is at least one dicarboxylic acid, at least one acid anhydride, or a combination thereof. According to embodiments of the disclosure, the molar ratio of the first reactant (i.e. diol) to the second reactant (i.e. dicarboxylic acid, acid anhydride, or a combination thereof) can be about 1:1 to 1.5:1. The temperature of the esterification can be 190° C. to 230° C., and the reaction time period can be 30 minutes to 8 hours. Next, a second composition is subjected to polycondensation, wherein the second composition includes at least one of the aforementioned oligomers (i.e. the polyester oligomer) and at least one epoxy resin with a secondary hydroxyl functional group. According to embodiments of the disclosure, the temperature of the polycondensation can be 230° C. to 260° C., and the reaction time period can be 30 minutes to 8 hours. According to embodiments of the disclosure, the weight ratio of the epoxy resin with a secondary hydroxyl functional group to the oligomer is 0.1:100 to 5:100, such as 0.1:100, 0.2:100, 0.5:100, 1:100, 2:100, 3:100, 4:100, or 5:100. According to embodiments of the disclosure, the second composition can consist of at least one oligomer and at least one epoxy resin with a secondary hydroxyl functional group. According to embodiments of the disclosure, the polycondensation is a melt reaction. According to embodiments of the disclosure, the second composition does not include solvent.

According to embodiments of the disclosure, the composition of the disclosure can further optionally include other components as known by those skilled in the art additive, in order to improve the properties of a cured product of the composition. The conventional additives include, but not limited to, flame retardant, viscosity modifier, thixotropic agent, leveling agent, surface treatment agent, or stabilizer. The additive can be used alone or in combination. The amount of additive is not limited and can be optionally modified by a person of ordinary skill in the field.

According to embodiments of the disclosure, the first composition can further include a catalyst, wherein the catalyst is organic zinc, organic titanium (such as tetrabutyl titanate), organic tin, sulfuric acid, potassium hydroxide, potassium carbonate, antimony trioxide, 4-dimethylaminopyridine (DMAP), or a combination thereof. The amount of catalyst can be 0.1 wt % to 3 wt %, based on the total weight of the first reactant and the second reactant.

According to embodiments of the disclosure, the first composition can further include an antioxidant. The antioxidant can be hindered phenol antioxidant, thioester antioxidant, or phosphite antioxidant. The amount of antioxidant can be 0.1 wt % to 10 wt %, based on the total weight of the first reactant and the second reactant.

In related arts, a chain extender (such as trihydric alcohol, ternary acid or chain extender with multi-reactive-functional groups (number of reactive-functional groups is greater than or equal to 3)) may be introduced by a blending process in order to form a hyper-branched structure to increase molecular chain entanglement and melt strength, thereby enhancing the melt strength and viscosity of the biodegradable polyester. The method employing the chain extender, however, is apt to rapidly increase the molecular weight of the obtained polyester, resulting in over-cross-linking degree or high degree of branching. As a result, the obtained polyester undergoes polymer gelation immediately, thereby reducing the processability and deteriorating the mechanical strength or biodegradability thereof. The disclosure employs the epoxy resin with a secondary hydroxyl functional group to react with the polyester oligomer to prepare a biodegradable polyester with high molecular chain entanglements enhanced by an intramolecular hydrogen bond caused by the secondary alcohol group. Therefore, the melt strength and melt flow index of the obtained biodegradable polyester can be enhanced to a suitable range on the premise that the biodegradability and mechanical strength of the obtained biodegradable polyester are not affected, thereby further improving the processability of the obtained biodegradable polyester. In addition, according to embodiments of the disclosure, since the molecular weight of the epoxy resin with a secondary hydroxyl functional group is not less than 300 g/mol and the epoxy resin merely has two reactive functional group, the amount of epoxy resin with a secondary hydroxyl functional group can be increased to 5 wt %(based on the weight of oligomer), thereby increasing the adjustability of the melt strength and melt flow index of the biodegradable polyester of the disclosure.

Below, exemplary embodiments will be described in detail so as to be easily realized by a person having ordinary knowledge in the art. The inventive concept may be embodied in various forms without being limited to the exemplary embodiments set forth herein.

### EXAMPLES

Preparation of Biodegradable Polyester

### Example 1

1,4-butanediol, succinic acid, tetrabutyl titanate, antimony trioxide and antioxidant were mixed to obtain a mixture, wherein the molar ratio of 1,4-butanediol to succinic acid was 1.4:1, the amount of tetrabutyl titanate was 0.025 wt %, the amount of antimony trioxide was 0.02 wt %, and the amount of antioxidant was 0.22 wt % (Irganox® 1010) (based on the total weight of 1,4-butanediol and succinic acid). Next, the mixture was subjected to an esterification at 200° C. for 60 minutes, obtaining polybutylene succinate (PBS) oligomer (with a number average molecular weight about 5,000 g/mol). Next, 100 parts by weight of polybutylene succinate (PBS) oligomer and 0.3 parts by weight of bisphenol A epoxy resin (with a trade number of Epikote 828, commercially available from Momentive) (having a molecular weight about 2,000 g/mol) were mixed, and the mixture was subjected to a melt reaction (i.e. without solvent) at 250° C. After reacting for 3 hours, Polyester material (1) was obtained.

### Example 2

Example 2 was performed in the same manner as in Example 1, except that Epikote 828 was replaced with Epikote 1001 (bisphenol A epoxy resin, commercially available from Momentive) (having a molecular weight about 1,000 g/mol), obtaining Polyester material (2).

### Example 3

Example 3 was performed in the same manner as in Example 1, except that Epikote 828 was replaced with Epikote 1004 (bisphenol A epoxy resin, commercially available from Momentive) (having a molecular weight about 1,500 g/mol), obtaining Polyester material (3).

### Example 4

Example 4 was performed in the same manner as in Example 1, except that Epikote 828 was replaced with Epikote 1007 (bisphenol A epoxy resin, commercially available from Momentive) (having a molecular weight about 2,200 g/mol), obtaining Polyester material (4).

### Example 5

Example 5 was performed in the same manner as in Example 1, except that Epikote 828 was replaced with Epikote 1009 (bisphenol A epoxy resin, commercially available from Momentive) (having a molecular weight about 2,500 g/mol), obtaining Polyester material (5).

### Example 6

Example 6 was performed in the same manner as in Example 2, except that the amount of Epikote 1001 was increased from 0.3 parts by weight to 1 part by weight, obtaining Polyester material (6).

### Example 7

Example 7 was performed in the same manner as in Example 2, except that the amount of Epikote 1001 was increased from 0.3 parts by weight to 2 parts by weight, obtaining Polyester material (7).

### Example 8

Example 8 was performed in the same manner as in Example 2, except that the amount of Epikote 1001 was increased from 0.3 parts by weight to 4 parts by weight, obtaining Polyester material (8).

### Example 9

Example 9 was performed in the same manner as in Example 2, except that the amount of Epikote 1001 was increased from 0.3 parts by weight to 5 parts by weight, obtaining Polyester material (9).

Comparative Example 1

1,4-butanediol, succinic acid, tetrabutyl titanate, antimony trioxide and antioxidant were mixed to obtain a mixture, wherein the molar ratio of 1,4-butanediol to succinic acid was 1.4:1, the amount of tetrabutyl titanate was 0.025 wt %, the amount of antimony trioxide was 0.02 wt %, and the amount of antioxidant was 0.22 wt % (Irganox® 1010 (based on the total weight of 1,4-butanediol and succinic acid). Next, the mixture was subjected to an esterification at 200° C. for 1 hour, and the mixture was subjected to a melt reaction (i.e. without solvent) at 250° C. After reacting for 3 hours, Polyester material (10) was obtained.

### Comparative Example 2

Comparative Example 2 was performed in the same manner as in Example 1, except that Epikote 828 was replaced with glycerol, obtaining Polyester material (11).

### Comparative Example 3

Next, 100 parts by weight of polybutylene succinate (PBS) (with a trade number of FZ91PD, commercially available from PTT-MCC) (having a molecular weight about 45,000 g/mol) and 0.3 parts by weight of Epikote 1001 was blended by a twin-screw extruder (with a length to diameter ratio (L/D ratio) of 40 to 60; a screw speed of 100 rpm; and a barrel temperature of 220° C.), obtaining Polyester material (12).

### Comparative Example 4

Comparative Example 4 was performed in the same manner as in Comparative Example 3, except that the amount of Epikote 1001 was increased from 0.3 parts by weight to 1 part by weight, obtaining Polyester material (13).

### Comparative Example 5

Comparative Example 5 was performed in the same manner as in Comparative Example 3, except that the amount of Epikote 1001 was increased from 0.3 parts by weight to 1.5 parts by weight, obtaining Polyester material (14). Herein, gelation of Polyester material (13) was observed, thus the material cannot be used to perform a subsequent process.

Next, the number average molecular weight, melt flow index, melt strength, tensile strength, and elongation of Polyester material (1)-(13) were measured, and the results are shown in Table 1. The method for measuring number average molecular weight, melt flow index, melt strength, tensile strength, and elongation are described as below:

Number average molecular weight (Mn) was determined by gel permeation chromatography (GPC). Melt flow index was determined by the method according to ASTM D 1238 (290° C./2.16 kg). Melt strength was determined by capillary rheometer and melt strength meter at a temperature of 140° C. under a wheel traction acceleration of 24 mm/s. Tensile strength was determined by the method according to ASTM D3574. Elongation was determined by the method according to ASTM D412 assisting in use of an universal tensile machine.

TABLE 1

| | | | | | number |
|---|---|---|---|---|---|
| | | | | | average |
| | tensile | | melt | melt | molecular |
| | strength | elongation | flow | strength | weight |
| | (kg/cm2) | (%) | index | (mN) | (g/mol) |
| Example 1 | >300 | >250 | 5.6 | 33.2 | 42,500 |
| Example 2 | >300 | >300 | 4.9 | 60.3 | 53,400 |
| Example 3 | >300 | >300 | 2.8 | 58.5 | 50,850 |
| Example 4 | >300 | >300 | 2.2 | 49.6 | 44,000 |
| Example 5 | >300 | >300 | 4.5 | 43.2 | 58,100 |
| Example 6 | >300 | >300 | 3.2 | 65.5 | 54,800 |
| Example 7 | >300 | >300 | 2.4 | 69.3 | 56,000 |
| Example 8 | >300 | >250 | 1.6 | 76.8 | 61,000 |
| Example 9 | >300 | >250 | 0.9 | 88.1 | 69,000 |
| Comparative | >300 | >300 | 22.5 | 13 | 40,500 |
| Example 1 | | | | | |
| Comparative | >300 | 165 | 10.2 | 23.4 | 37,900 |
| Example 2 | | | | | |
| Comparative | >300 | 245 | 1.6 | 32.8 | 55,000 |
| Example 3 | | | | | |
| Comparative | >300 | 185 | 0.6 | 36.5 | 59,000 |
| Example 4 | | | | | |

As shown in Table 1, when preparing polyester (PBS) in the absence of the epoxy resin with a secondary hydroxyl functional group of the disclosure, the obtained polyester (i.e. Polyester (10) of Comparative Example 1) exhibits relatively high melt flow index and relatively low melt strength. As shown in Example 9, even though that the amount of epoxy resin with a secondary hydroxyl functional group of the disclosure was increased to 5 wt %, the melt flow index, melt strength, and mechanical strength of the obtained polyester (i.e. Polyester (10) of Comparative Example 1) are still within a specific range. In addition, according to embodiments of the disclosure, when gradually increasing the amount of Epikote 1001 from 5 parts by weight to 8 parts by weight, it is obviously observed that the melt strength, melt flow index and biodegradability of the obtained Polyester material decreases with the increase of Epikote 1001. In addition, when replacing the epoxy resin with a secondary hydroxyl functional group of the disclosure with glycerol (trihydric alcohol), the obtained polyester (i.e. Polyester (11) of Comparative Example 1) exhibits obviously poor elongation. Furthermore, when blending the epoxy resin with a secondary hydroxyl functional group of the disclosure with PBS (i.e. Comparative Example 3-5), gelation of Polyester material (13) (the amount of epoxy resin with a secondary hydroxyl functional group was 1.5 wt %) was observed, thus Polyester material (13) cannot be used to perform a subsequent process.

### Example 10

1,4-butanediol, succinic acid, terephthalic acid, tetrabutyl titanate, antimony trioxide and antioxidant were mixed to obtain a mixture, wherein the ratio of the mole of 1,4-butanediol to the total mole of succinic acid and terephthalic acid was 1.4:1, the molar ratio of terephthalic acid to succinic acid was 1:9, the amount of tetrabutyl titanate was 0.025 wt %, the amount of antimony trioxide was 0.02 wt %, and the amount of antioxidant was 0.22 wt % (Irganox® 1010) (based on the total weight of 1,4-butanediol, succinic acid and terephthalic acid). Next, the mixture was subjected to an esterification at 200° C. for 60 minutes, obtaining polybutylene succinate/terephthalate (PBST) oligomer (number average having a molecular weight about 4,000 g/mol). Next, 100 parts by weight of polybutylene succinate/terephthalate (PBST) oligomer and 0.3 parts by weight of bisphenol A epoxy resin (with a trade number of Epikote 1001, commercially available from Momentive) (having a molecular weight about 1,000 g/mol) were mixed, and the mixture was subjected to a melt reaction (i.e. without solvent) at 250° C. After reacting for 4 hours, Polyester material (15) was obtained.

Example 11

1,4-butanediol, succinic acid, adipic acid, tetrabutyl titanate, antimony trioxide and antioxidant were mixed to obtain a mixture, wherein the ratio of the mole of 1,4-butanediol to the total mole of succinic acid and adipic acid was 1.4:1, the molar ratio of adipic acid to succinic acid was 1:9, the amount of tetrabutyl titanate was 0.025 wt %, the amount of antimony trioxide was 0.02 wt %, and the amount of antioxidant was 0.22 wt % (Irganox® 1010) (based on the total weight of 1,4-butanediol, succinic acid and terephthalic acid). Next, the mixture was subjected to an esterification at 200° C. for 60 minutes, obtaining polybutylene succinate adipate (PBSA) oligomer (number average having a molecular weight about 3,500 g/mol). Next, 100 parts by weight of polybutylene succinate/terephthalate(PBST) oligomer and 0.3 parts by weight of bisphenol A epoxy resin (with a trade number of Epikote 1001, commercially available from Momentive) (having a molecular weight about 1,000 g/mol) were mixed, and the mixture was subjected to a melt reaction (i.e. without solvent) at 250° C. After reacting for 4 hours, Polyester material (16) was obtained.

### Example 12

1,4-butanediol, succinic acid, ethanedioic acid, tetrabutyl titanate, antimony trioxide and antioxidant were mixed to obtain a mixture, wherein the ratio of the mole of 1,4-butanediol to the total mole of succinic acid and ethanedioic acid was 1.4:1, the molar ratio of ethanedioic acid to succinic acid was 1:9, the amount of tetrabutyl titanate was 0.025 wt %, the amount of antimony trioxide was 0.02 wt %, and the amount of antioxidant was 0.22 wt % (Irganox® 1010) (based on the total weight of 1,4-butanediol, succinic acid and terephthalic acid). Next, the mixture was subjected to an esterification at 200° C. for 60 minutes, obtaining polyester oligomer (number average having a molecular weight about 3,000 g/mol). Next, 100 parts by weight of polyester oligomer and 0.3 parts by weight of bisphenol A epoxy resin (with a trade number of Epikote 1001, commercially available from Momentive) (having a molecular weight about 1,000 g/mol) were mixed, and the mixture was subjected to a melt reaction (i.e. without solvent) at 250° C. After reacting for 4 hours, Polyester material (17) was obtained.

Example 13

Example 13 was performed in the same manner as in Example 10, except that the molar ratio of terephthalic acid to succinic acid was adjusted from 1:9 to 1.5:8.5, obtaining Polyester material (18).

### Example 14

Example 14 was performed in the same manner as in Example 11, except that the molar ratio of adipic acid to succinic acid was adjusted from 1:9 to 1.5:8.5, obtaining Polyester material (19).

Next, the number average molecular weight, melt flow index, melt strength, tensile strength, and elongation of Polyester materials (15)-(19) were measured, and the results are shown in Table 2.

TABLE 2

| | | | | | number |
|---|---|---|---|---|---|
| | | | | | average |
| | tensile | | melt | melt | molecular |
| | strength | elongation | flow | strength | weight |
| | (kg/cm2) | (%) | index | (mN) | (g/mol) |
| Example 10 | 275 | 758 | 2.9 | 62.9 | 43,900 |
| Example 11 | 262 | 695 | 1.8 | 68.5 | 59,800 |
| Example 12 | 303 | 58 | 3.3 | 48.8 | 42,500 |
| Example 13 | 254 | 822 | 2.6 | 69.6 | 49,700 |
| Example 14 | 305 | 548 | 3.5 | 70.2 | 52,000 |

As shown in Table 2, the method for preparing a biodegradable polyester of the disclosure can be used in the preparation, employing various monomers (such as a diol for use in concert with two dicarboxylic acids) for biodegradable polyester.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A biodegradable polyester, which is a product of a reactant (A) and a reactant (B) via polycondensation, wherein the reactant (A) is a product of a reactant (C) and a reactant (D) via an esterification reaction, wherein the reactant (B) is at least one epoxy resin with a secondary hydroxyl functional group, the reactant (C) is at least one diol, and the reactant (D) is at least one dicarboxylic acid, at least one acid anhydride, or a combination thereof.

2. The biodegradable polyester as claimed in claim 1, wherein the number average molecular weight of the epoxy resin with a secondary hydroxyl functional group is greater than or equal to 300 g/mol.

3. The biodegradable polyester as claimed in claim 1, wherein the epoxy resin with a secondary hydroxyl functional group has a repeating unit, and the repeating unit has a secondary hydroxyl functional group.

4. The biodegradable polyester as claimed in claim 1, wherein the epoxy resin with a secondary hydroxyl functional group is a diglycidyl-ether-based epoxy resin having a secondary hydroxyl functional group.

5. The biodegradable polyester as claimed in claim 1, wherein the epoxy resin with a secondary hydroxyl functional group is bisphenol A type diglycidyl ether epoxy resin, novolac diglycidyl ether epoxy resin, bisphenol F type diglycidyl ether epoxy resin, bisphenol S type diglycidyl ether epoxy resin, alicyclic diglycidyl ether epoxy resin, halogenated bisphenol A type diglycidyl ether epoxy resin, hydrogenation bisphenol A type diglycidyl ether epoxy resin, or a combination thereof.

6. The biodegradable polyester as claimed in claim 1, wherein the epoxy resin with a secondary hydroxyl functional group has a structure represented by Formula (I) or Formula (II): 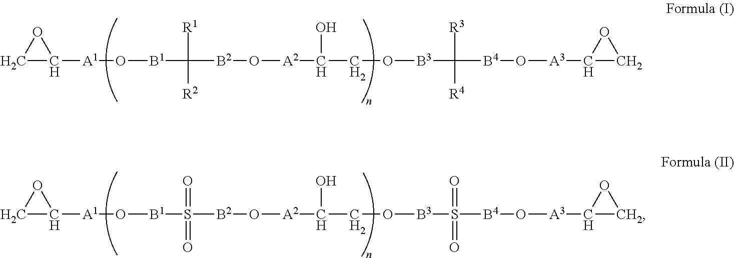
wherein R¹-R⁴ are independently hydrogen, fluorine, C₁₋₆ alkyl group, or C₁₋₆ fluoroalkyl group; A¹, A² and A³ are independently C₁₋₈ alkylene group; B¹, B², B³, and B⁴ are independently C₆₋₁₈ arylene group, C₄₋₈ cycloalkylene group, C₄₋₁₈ heteroarylene group, C₄₋₁₂ alicyclic alkylene group, or divalent C₇-C₂₅ alkylaryl group; and, n is 0, or an integer from 1-30.

7. The biodegradable polyester as claimed in claim 6, wherein the reactant (B) is at least two epoxy resins with a secondary hydroxyl functional group, and the average value of n is 0.1 to 29.

8. The biodegradable polyester as claimed in claim 1, wherein the reactant (A) is 100 parts by weight and the reactant (B) is 0.1-5 parts by weight.

9. The biodegradable polyester as claimed in claim 1, wherein the dicarboxylic acid is compound having a structure represented by Formula (III): 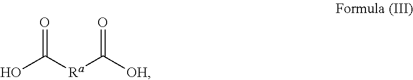
wherein R^{a} is independently C₁₋₈ alkylene group, C₆₋₁₈ arylene group, C₄₋₈ cycloalkylene group, C₄₋₁₈ heteroarylene group, C₄₋ alicyclic alkylene group, or divalent C₇-C₂₅ alkylaryl group.

10. The biodegradable polyester as claimed in claim 1, wherein the acid anhydride is a compound having a structure represented by Formula (IV) or Formula (V): 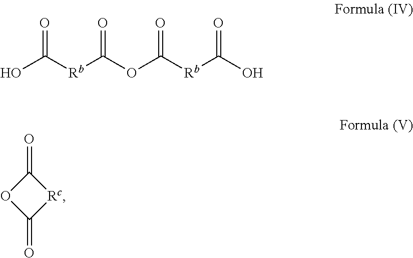
wherein R^{b} is independently C₁₋₈ alkylene group, C₆₋₁₈ arylene group, C₄-C₈ cycloalkylene group, C₄₋₁₈ heteroarylene group, C₄₋₁₂ alicyclic alkylene group, or divalent C₇₋₂₅ alkylaryl group; and, R^{c} is independently C₂₋₈ alkylene group, C₆₋₁₈ arylene group, C₅₋₈ cycloalkylene group, C₄₋₁₈ heteroarylene group, C₄₋₁₂ alicyclic alkylene group, or divalent C₇-C₂₅ alkylaryl group.

11. The biodegradable polyester as claimed in claim 1, wherein the diol is a compound having a structure represented by Formula (VI):
HO—R^{d}—OH_{Formula} (VI),
wherein R^{d} is independently C₁₋₈ alkylene group, C₆₋₁₈ arylene group, C₄₋₈ cycloalkylene group, C₄₋₁₈ heteroarylene group, C₄₋₁₂ alicyclic alkylene group, or divalent C₇-C₂₅ alkylaryl group.

12. The biodegradable polyester as claimed in claim 1, wherein the molar ratio of the reactant (C) to the reactant (D) is 1:1 to 1.5:1.

13. The biodegradable polyester as claimed in claim 1, wherein the number average molecular weight of the biodegradable polyester is 5,000 g/mol to 500,000 g/mol.

14. The biodegradable polyester as claimed in claim 1, wherein the biodegradable polyester has a melt strength of 30 mN to 100 mN.

15. The biodegradable polyester as claimed in claim 1, wherein the biodegradable polyester has a melt flow index of 0.5 g/10 min to 10 g/10 min.

16. A method for preparing biodegradable polyester, comprising:
subjecting a first composition to an esterification, obtaining an oligomer, wherein the first composition comprises a first reactant and a second reactant, wherein the first reactant is at least one diol, and the second reactant is at least one dicarboxylic acid, at least one acid anhydride, or a combination thereof; and
subjecting a second composition to polycondensation, wherein the second composition comprises at least one the oligomer and at least one epoxy resin with a secondary hydroxyl functional group.

17. The method for preparing biodegradable polyester as claimed in claim 16, wherein the weight ratio of the epoxy resin with a secondary hydroxyl functional group to the oligomer is 0.1:100 to 5:100.

18. The method for preparing biodegradable polyester as claimed in claim 16, wherein the number average molecular weight of the oligomer is 100 g/mol to 8,000 g/mol.

19. The method for preparing biodegradable polyester as claimed in claim 16, wherein the second composition does not comprise a solvent.

20. The method for preparing biodegradable polyester as claimed in claim 16, wherein the molar ratio of the first reactant to the second reactant is 1:1 to 1.5:1.
